(19) United States
(12) Patent Application Publication
(10) Pub. No.: US 2022/0402329 A1
(43) Pub. Date: Dec. 22, 2022

(54) AIR CONDITIONING SYSTEM OF VEHICLE AND CONTROL METHOD THEREOF

(71) Applicants: Hyundai Motor Company, Seoul (KR); Kia Corporation, Seoul (KR)

(72) Inventors: Sejun PARK, Suwon-Si (KR); Seunghan LEE, Uiwang-Si (KR); Heejung YOON, Goyang-Si (KR); Jinhoe HEO, Yangju-Si (KR); Jonghyuck KIM, Hwaseong-Si (KR); In Eok CHO, Incheon (KR)

(73) Assignees: Hyundai Motor Company, Seoul (KR); Kia Corporation, Seoul (KR)

(21) Appl. No.: 17/837,850

(22) Filed: Jun. 10, 2022

(30) Foreign Application Priority Data
Jun. 21, 2021 (KR) 10-2021-0080099

(51) Int. Cl. B60H 1/00

(52) U.S. Cl. CPC B60H 1/00742; B60H 1/00785

(57) ABSTRACT

An air conditioning system of a vehicle and a control method thereof, includes a distance sensor that is configured to detect a distance from the vehicle to another vehicle in front of the vehicle; a humidity sensor that is configured to detect an inside humidity of the vehicle; an inside temperature sensor that is configured to detect an inside temperature of the vehicle; an outside temperature sensor that is configured to detect an outside temperature of the vehicle; and a controller electrically connected to the distance sensor, the humidity sensor, the inside temperature sensor, and the outside temperature sensor and configured for determining an air conditioning mode of the vehicle based on the distance to another vehicle in front detected by the distance sensor, the inside humidity of the vehicle detected by the humidity sensor, the inside temperature of the vehicle detected by the inside temperature sensor, and the outside temperature of the vehicle detected by the outside temperature sensor.

### CROSS-REFERENCE TO RELATED APPLICATION

The present application claims priority to Korean Patent Application No. 10-2021-0080099 filed on Jun. 21, 2021, the entire contents of which is incorporated herein for all purposes by this reference.

### BACKGROUND OF THE PRESENT DISCLOSURE

### Field of the Present Disclosure

The present disclosure relates to an air conditioning system of a vehicle and a control method thereof, and more particularly, to an air conditioning system of a vehicle and a control method thereof which may minimize power consumption and maintain a comfortable passenger compartment.

### Description of Related Art

In general, an air conditioner for a vehicle includes an air conditioning system, which is an air conditioner for cooling and heating an interior of the vehicle.

The air conditioning system is configured to cool the interior of the vehicle by use of a heat exchange medium, which is discharged from a compressor and exchanges heat through an evaporator while circulating through a condenser, a receiver drier, an expansion valve, the evaporator, and the compressor, or it heats the interior of the vehicle by use of cooling water that exchanges heat through a heater.

That is, in the air conditioning system, a high-temperature and high-pressure gaseous refrigerant compressed by the compressor is condensed through the condenser, then is evaporated by the evaporator through the receiver drier and the expansion valve to lower the internal temperature and humidity in a summer cooling mode.

In the air conditioning system, the evaporator is provided with a heater core, and it is provided at the inside of a heating, ventilation, and air conditioning (HVAC) module that flows outside air that flows into the vehicle while the vehicle is running, into the interior of the vehicle.

In an outside range of a lowest temperature setting range, the HVAC module maintains the vehicle interior at a set temperature, by passing some of the outside air that has passed through the evaporator to the heater core by a temperature control door and by allowing other some thereof to bypass the heater core.

In a conventional HVAC module, air flow is operated in an inside air mode in which air inside the passenger compartment of the vehicle is introduced back into the passenger compartment, in an outside air mode in which outside air of the vehicle is introduced into the passenger compartment, or in a mixing air mode in which the outside air of the vehicle and the inside air of the passenger compartment are introduced into the passenger compartment. Here, the mixing mode means a mode in which the outside air and the inside air of the vehicle are mixed and used for air conditioning.

In the conventional air conditioning system of the HVAC module, when a temperature of the inside air is lower than that of the outside air, and when the passenger compartment of the vehicle is cooled by use of the outside air mode, power consumption increases compared to the inside air mode, and fuel efficiency of the vehicle deteriorates.

Furthermore, when the passenger compartment is cooled in the mixing air mode, exhaust gas discharged from a vehicle in front flows into the passenger compartment, and comfort felt by a passenger in the vehicle deteriorates.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an air conditioning system of a vehicle and a control method thereof which may minimize power consumption to improve fuel efficiency of a vehicle and may maintain comfort inside a passenger compartment.

Various aspects of the present disclosure are directed to providing an air conditioning system of a vehicle, including: a distance sensor that is configured to detect a distance from the vehicle to another vehicle in front of the vehicle; a humidity sensor that is configured to detect an inside humidity of the vehicle; an inside temperature sensor that is configured to detect an inside temperature of the vehicle; an outside temperature sensor that is configured to detect an outside temperature of the vehicle; and a controller electrically connected to the distance sensor, the humidity sensor, the inside temperature sensor, and the outside temperature sensor and configured for determining an air conditioning mode of the vehicle based on the distance to another vehicle in front detected by the distance sensor, the inside humidity of the vehicle detected by the humidity sensor, the inside temperature of the vehicle detected by the inside temperature sensor, and the outside temperature of the vehicle detected by the outside temperature sensor.

The air conditioning mode may include an inside air mode that recirculates only inside air of the vehicle, an outside air mode that flows outside air of the vehicle into the interior of the vehicle, and a mixing air mode of flowing the inside air and the outside air of the vehicle into the interior of the vehicle.

When the inside humidity of the vehicle is less than or equal to a set humidity and the distance to the vehicle in front is within a set distance, the controller may set the air conditioning mode to the inside air mode.

When a time operating in the inside air mode passes a set time, the controller may set the air conditioning mode to the mixing air mode.

The set time may be adjusted according to a number of passengers in the vehicle.

The set time may decrease as the number of passengers in the vehicle increases.

When the inside humidity of the vehicle exceeds the set humidity, the controller may set the air conditioning mode of the vehicle to the mixing air mode.

When the inside humidity of the vehicle is less than or equal to the set humidity, the distance to the vehicle in front is greater than or equal to the set distance, and the inside temperature is higher than the outside temperature, the controller may set the air conditioning mode of the vehicle to the mixing air mode.

Various aspects of the present disclosure are directed to providing a method of controlling an air conditioning system of a vehicle, including: determining whether an inside humidity of a vehicle is less than or equal to a set humidity; determining whether a distance from the vehicle to another vehicle in front of the vehicle is within a set distance; determining whether an inside temperature of the vehicle is higher than an outside temperature thereof; and determining an air conditioning mode based on the inside humidity of the vehicle, the distance to the vehicle in front, the inside temperature, and the outside temperature.

The air conditioning mode may include an inside air mode that recirculates only inside air of the vehicle, an outside air mode that flows outside air of the vehicle into the interior of the vehicle, and a mixing air mode of flowing the inside air and the outside air of the vehicle into the interior of the vehicle.

When the inside humidity of the vehicle is less than or equal to a set humidity and the distance to the vehicle in front is within a set distance, the air conditioning mode may be set as the inside air mode.

When a time operating in the inside air mode passes a set time, the air conditioning mode may be set as the mixing air mode.

The set time may be adjusted according to a number of passengers in the vehicle.

The set time may decrease as the number of passengers in the vehicle increases.

When the inside humidity of the vehicle exceeds the set humidity, the air conditioning mode may be set as the mixing air mode.

When the inside humidity of the vehicle is less than or equal to the set humidity, the distance to the vehicle in front is greater than or equal to the set distance, and the inside temperature is higher than the outside temperature, the air conditioning mode may be set as the mixing air mode.

According to the air conditioning system of the vehicle according to the exemplary embodiment of the present disclosure as described above, by switching an air conditioning mode to an inside air mode or a mixing air mode based on a difference between an inside temperature and an outside temperature and a distance to another vehicle in front, it is possible to minimize power consumption for cooling the vehicle and to improve fuel efficiency of the vehicle.

Furthermore, it is possible to maintain the interior of a passenger compartment comfortable by preventing exhaust gas discharged from a vehicle in front from flowing into the passenger compartment of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view of a configuration of an air conditioning system of a vehicle according to various exemplary embodiments of the present disclosure.

FIG. 2A, FIG. 2B and FIG. 2C are schematic views for explaining an air conditioning mode of an air conditioning system of a vehicle according to various exemplary embodiments of the present disclosure.

FIG. 3 is a block diagram of an air conditioning system of a vehicle according to various exemplary embodiments of the present disclosure.

FIG. 4 is an operational flowchart of an air conditioning system of a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Exemplary embodiments of the present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

To clearly describe the present disclosure, parts that are irrelevant to the description are omitted, and identical or similar constituent elements throughout the specification are denoted by the same reference numerals.

Furthermore, because the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Hereinafter, an air conditioning system of a vehicle according to various exemplary embodiments of the present disclosure will be described in detail with reference to the accompanying drawings.

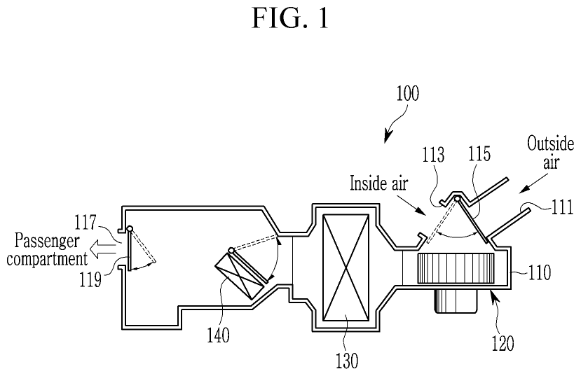

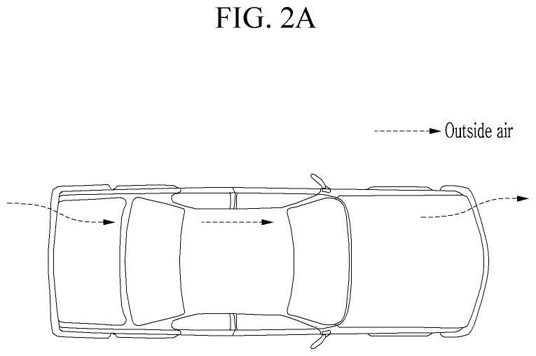

FIG. 1 is a schematic view of a configuration of an air conditioning system of a vehicle according to various exemplary embodiments of the present disclosure.

As shown in FIG. 1, an air conditioning system of a vehicle according to various exemplary embodiments of the present disclosure may include an air conditioning case 110, an outside air inlet 111 and an inside air inlet 113 formed in the air conditioning case 110, and a door 115 provided between the outside air inlet 111 and the inside air inlet 113.

A blower 120, an evaporator 130, and a heater core may be sequentially provided in the air conditioning case 110 along an air flow direction. For example, the evaporator 130 may be provided downstream of the blower 120 and the heater core may be provided downstream of the evaporator 130, but the scope of the present disclosure is not limited thereto, and disposition of the blower 120, the evaporator 130, and the heater core may be appropriately changed according to needs of a designer.

The evaporator 130 may cool air blown by operation of the blower 120. In the exemplary embodiment of the present disclosure, the evaporator 130 configures a known air conditioner together with a compressor, a condenser, an expansion valve, a circulation pump, and the like. The evaporator 130 may cool air (inside air and/or outside air) through heat-exchange with a refrigerant circulated by operations of the compressor and the circulation pump of a refrigeration cycle.

An air vent 117 for discharging the air cooled through the evaporator 130 into the passenger compartment of the vehicle is formed in the air conditioning case 110, and a discharge door 119 for controlling an amount of the air discharged into the passenger compartment is provided in the air vent 117.

The outside air inlet 111 fluidically communicates with the outside of the vehicle and introduces the outside air of the vehicle. The inside air inlet 113 fluidically communicates with the internal (passenger compartment) of the vehicle and introduces the inside air of the vehicle.

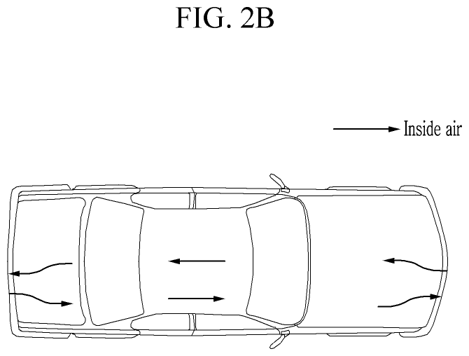

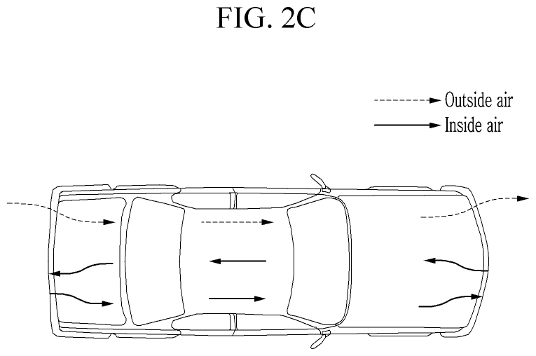

The door 115 is rotatably provided in the air conditioning case 110. The door 115 selectively opens or closes the outside air inlet 111 and the inside air inlet 113 while rotating between the outside air inlet 111 and the inside air inlet 113. Through this, the air conditioning mode of the air conditioning system according to the exemplary embodiment of the present disclosure may operate as the inside air mode, the outside air mode, and the mixing air mode (see FIG. 2A to FIG. 2C).

Referring to FIG. 2A, in the outside air mode, by rotation of the door 115, the outside air inlet 111 is opened and the inside air inlet 113 is closed. Accordingly, as the outside air flows into the passenger compartment of the vehicle, air conditioning is performed by the air conditioner. That is, the outside air mode is an air conditioning mode in which the outside air of the vehicle is introduced into the interior of the vehicle. In the outside air mode, the outside air introduced through the outside air inlet 111 is cooled through the evaporator 130 and then discharged to the internal (passenger compartment) of the vehicle through the air vent 117.

Referring to FIG. 2B, in the inside air mode, by rotation of the door 115, the outside air inlet 111 is closed and the inside air inlet 113 is opened. Accordingly, the outside air does not flow into the passenger compartment of the vehicle, and air conditioning is performed by the air conditioning system while the inside air in the passenger compartment is circulated through the inside air inlet 113 to the passenger compartment of the vehicle. That is, the inside air mode is an air conditioning mode in which the outside air of the vehicle does not flow into the interior of the vehicle and only the inside air of the vehicle is recirculated. In the inside air mode, the inside air of the vehicle introduced through the inside air inlet 113 is cooled through the evaporator 130 and then discharged to the internal (passenger compartment) of the vehicle through the air vent 117.

Referring to FIG. 2C, in the mixing air mode, the outside air inlet 111 and the inside air inlet 113 are partially opened by the rotation of the door 115, respectively. Accordingly, as the outside air and the inside air flow into the passenger compartment of the vehicle, air conditioning is performed by the air conditioning system. That is, the mixing air mode is an air conditioning mode in which the inside air of the vehicle and the outside air of the vehicle are introduced into the interior of the vehicle. In the mixing air mode, the inside air of the vehicle introduced through the inside air inlet 113 and the outside air of the vehicle introduced through the outside air inlet 111 are cooled through the evaporator 130 and then are discharged into the internal (passenger compartment) of the vehicle through the air vent 117.

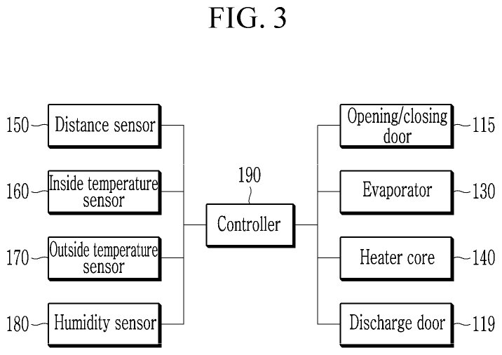

Referring to FIG. 3, the air conditioning system of the vehicle according to the exemplary embodiment of the present disclosure may include a distance sensor 150, an inside temperature sensor 160, an outside temperature sensor 170, a humidity sensor 180, and a controller 190.

The distance sensor 150 detects a distance to another vehicle in front, and the distance to the vehicle in front detected by the distance sensor 150 is transmitted to the controller 190.

The inside temperature sensor 160 detects an inside temperature of the vehicle, and the inside temperature of the vehicle detected by the inside temperature sensor 160 is transmitted to the controller 190.

The outside temperature sensor 170 detects an outside temperature of the vehicle, and the outside temperature of the vehicle detected by the outside temperature sensor 170 is transmitted to the controller 190.

The humidity sensor 180 detects an inside humidity of the vehicle, and the inside humidity of the vehicle detected by the humidity sensor 180 is transmitted to the controller 190.

The controller 190 determines an air conditioning mode based on a distance to the vehicle in front detected by the distance sensor 150, an inside temperature of the vehicle detected by the inside temperature sensor 160, an outside temperature of the vehicle detected by the outside temperature sensor 170, and an inside humidity of the vehicle detected by the humidity sensor 180.

To the present end, the controller 190 may be provided as at least one processor executed by a predetermined program, and the predetermined program is configured to perform respective steps of a method of controlling the air conditioning system of the vehicle according to the exemplary embodiment of the present disclosure.

Meanwhile, the air conditioning system of the vehicle according to the exemplary embodiment of the present disclosure may include a passenger detecting sensor provided on a seat of the vehicle to detect whether or not a passenger is in the vehicle. The passenger detecting sensor may be implemented through a pressure sensor provided on the seat of the vehicle, but the scope of the present disclosure is not limited thereto. The passenger detecting sensor may be provided on all seats of the vehicle, and the passenger detecting sensor detects whether or not a passenger is accommodated on the seat to transmit it to the controller 190. The controller 190 may determine the number of passengers in the vehicle through the passenger detecting sensor.

Hereinafter, an operation of the air conditioning system of the vehicle according to the exemplary embodiment of the present disclosure as described above will be described with reference to the accompanying drawings.

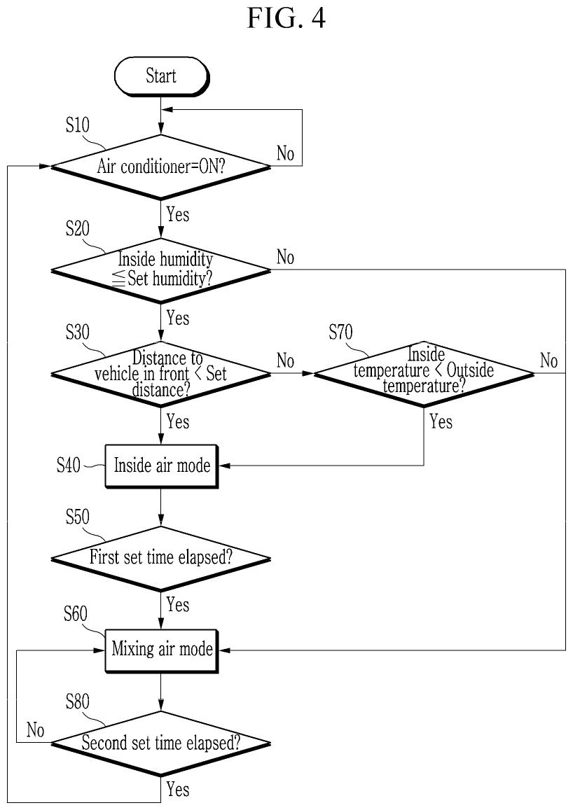

FIG. 4 is an operational flowchart of an air conditioning system of a vehicle according to various exemplary embodiments of the present disclosure.

Referring to FIG. 4, in a state in which the air conditioner is turned on (S10), the controller 190 compares the inside humidity of the vehicle detected by the humidity sensor 180 with a set humidity, and determines whether the inside humidity of the vehicle detected by the humidity sensor 180 is equal to or less than the set humidity (S20).

When the inside humidity of the vehicle exceeds the set humidity, the controller 190 controls the air conditioning mode as the mixing air mode. When the inside humidity of the vehicle is high, the air conditioning mode of the vehicle is operated as the mixing air mode (S60).

When the inside humidity of the vehicle is high, frost may form on the windshield and interfere with safe driving. In the instant case, the air conditioning mode of the vehicle is operated as the mixing air mode to prevent the frost from being formed on the windshield by partially introducing the outside air into the interior of the vehicle.

When the inside humidity of the vehicle is less than or equal to the set humidity, the controller 190 compares the distance to the vehicle in front detected by the distance sensor 150 and the set distance, and determines whether the distance to the vehicle in front detected by the distance sensor 150 is within the set distance (S30).

When the inside humidity of the vehicle is less than or equal to the set humidity and the distance to the vehicle in front is within the set distance, the controller 190 controls the air conditioning mode as the inside air mode (S40).

When the inside humidity of the vehicle is less than or equal to the set humidity, a possibility of frost forming on the windshield is very low, and when the distance to the vehicle in front is within the set distance, there is a high possibility that exhaust gas discharged from the vehicle in front flows into the interior of the vehicle. Accordingly, in the instant case, by driving the air conditioning mode as the inside air mode, the exhaust gas discharged from the vehicle in front is prevented from flowing into the interior of the vehicle.

While the air conditioning mode is operating as the inside air mode, the controller 190 determines whether a set time has elapsed. That is, the controller 190 determines whether the set time of operating in the inside air mode has elapsed (S50).

When the time of operating in the inside air mode passes the set time, the controller 190 changes the air conditioning mode to the mixing air mode (S60). In the instant case, the set time may be changed according to the number of passengers in the vehicle. In the instant case, as the number of passengers in the vehicle increases, the set time may be determined to be shorter. For example, when the number of passengers in the vehicle is one, the set time may be set to 100 seconds, when the number of passengers is two, the set time may be set to 80 seconds, when the number of passengers is three, the set time may be set to 60 seconds, and when the number of passengers is four, the set time may be set to 40 seconds.

While the air conditioning mode operates as the inside air mode, an amount of carbon dioxide in the interior of the vehicle increases due to breathing of the passenger in the vehicle. Accordingly, when the set time elapses, the air conditioning mode is changed to the mixing air mode, and outside air is introduced into the interior of the vehicle.

While the air conditioning mode is operating as the mixing air mode, the controller 190 determines whether a second set time has elapsed (S80). When the second set time elapses, the controller 190 moves to step S10.

When the inside humidity of the vehicle is less than or equal to the set humidity and the distance to the vehicle in front is greater than or equal to the set distance, the controller 190 compares the outside temperature detected by the outside temperature sensor 170 with the inside temperature detected by the inside temperature sensor 160, and determines whether the outside temperature is higher than the inside temperature (S70).

When the inside humidity of the vehicle is less than or equal to the set humidity, the distance to the vehicle in front is greater than or equal to the set distance, and the outside temperature is higher than the inside temperature, the controller 190 sets the air conditioning mode to the inside air mode (S40).

That is, when the outside temperature is higher than the inside temperature, hot outside air is prevented from flowing into the interior of the vehicle, reducing power consumed due to excessive operation of the air conditioner, improving fuel efficiency of the vehicle.

When the inside humidity of the vehicle is less than or equal to the set humidity, the distance to the vehicle in front is greater than or equal to the set distance, and the outside temperature is lower than the inside temperature (S70), the controller 190 sets the air conditioning mode to the mixing air mode (S60).

That is, when the outside temperature is lower than the inside temperature, by allowing cold outside air to flow into the interior of the vehicle, power consumption caused by excessive operation of the air conditioner may be reduced, improving fuel efficiency of the vehicle.

According to the air conditioning system of the vehicle and the control method thereof according to the exemplary embodiment of the present disclosure as described above, by switching the air conditioning mode to the inside air mode or the mixing air mode based on a difference between the inside temperature and the outside temperature and the distance to a vehicle in front, it is possible to minimize power consumption for cooling the vehicle and to improve fuel efficiency of the vehicle. Furthermore, it is possible to maintain the inside of the passenger compartment comfortable by preventing the exhaust gas discharged from the vehicle in front from flowing into the passenger compartment of the vehicle.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An air conditioning system of a vehicle, the system including:
a distance sensor that is configured to detect a distance from the vehicle to another vehicle in front of the vehicle;
a humidity sensor that is configured to detect an inside humidity of the vehicle;
an inside temperature sensor that is configured to detect an inside temperature of the vehicle;
an outside temperature sensor that is configured to detect an outside temperature of the vehicle; and
a controller electrically connected to the distance sensor, the humidity sensor, the inside temperature sensor, and the outside temperature sensor and configured for determining an air conditioning mode of the vehicle based on the distance to another vehicle in front detected by the distance sensor, the inside humidity of the vehicle detected by the humidity sensor, the inside temperature of the vehicle detected by the inside temperature sensor, and the outside temperature of the vehicle detected by the outside temperature sensor.

2. The air conditioning system of the vehicle of claim 1, wherein the air conditioning mode includes:
an inside air mode of only recirculating inside air of the vehicle in the vehicle,
an outside air mode of flowing outside air of the vehicle into an interior of the vehicle, and
a mixing air mode of flowing the inside air and the outside air of the vehicle into the interior of the vehicle.

3. The air conditioning system of the vehicle of claim 2, wherein when the inside humidity of the vehicle is less than or equal to a set humidity and the distance to the vehicle in front is within a set distance, the controller is configured to set the air conditioning mode to the inside air mode.

4. The air conditioning system of the vehicle of claim 3, wherein when a time operating in the inside air mode passes a set time, the controller is configured to set the air conditioning mode to the mixing air mode.

5. The air conditioning system of the vehicle of claim 4, wherein the set time is adjusted according to a number of passengers in the vehicle.

6. The air conditioning system of the vehicle of claim 5, wherein the set time decreases as the number of passengers in the vehicle increases.

7. The air conditioning system of the vehicle of claim 2, wherein when the inside humidity of the vehicle exceeds the set humidity, the controller is configured to set the air conditioning mode of the vehicle to the mixing air mode.

8. The air conditioning system of the vehicle of claim 3, wherein when the inside humidity of the vehicle is less than or equal to the set humidity, the distance to the vehicle in front is greater than or equal to the set distance, and the inside temperature is higher than the outside temperature, the controller is configured to set the air conditioning mode of the vehicle to the mixing air mode.

9. The air conditioning system of the vehicle of claim 3, wherein when the inside humidity of the vehicle is less than or equal to the set humidity, the distance to the vehicle in front is greater than or equal to the set distance, and the inside temperature is lower than the outside temperature, the controller is configured to set the air conditioning mode of the vehicle to the inside air mode.

10. A method of controlling an air conditioning system of a vehicle, the method comprising:
determining whether an inside humidity of the vehicle is less than or equal to a set humidity;
determining whether a distance from the vehicle to another vehicle in front of the vehicle is within a set distance;
determining whether an inside temperature of the vehicle is higher than an outside temperature thereof; and
determining an air conditioning mode based on the inside humidity of the vehicle, the distance to the vehicle in front, the inside temperature, and the outside temperature.

11. The method of controlling the air conditioning system of the vehicle of claim 10, wherein the air conditioning mode includes:
an inside air mode of only recirculating inside air of the vehicle in the vehicle,
an outside air mode that flows outside air of the vehicle into an interior of the vehicle, and
a mixing air mode of flowing the inside air and the outside air of the vehicle into the interior of the vehicle.

12. The method of claim 11, wherein when the inside humidity of the vehicle is less than or equal to a set humidity and the distance to the vehicle in front is within a set distance, the air conditioning mode is set as the inside air mode.

13. The method of claim 11, wherein when a time operating in the inside air mode passes a set time, the air conditioning mode is set as the mixing air mode.

14. The method of claim 11, wherein the set time is adjusted according to a number of passengers in the vehicle.

15. The method of claim 14, wherein the set time decreases as the number of passengers in the vehicle increases.

16. The method of claim 11, wherein when the inside humidity of the vehicle exceeds the set humidity, the air conditioning mode is set as the mixing air mode.

17. The method of claim 12, wherein when the inside humidity of the vehicle is less than or equal to the set humidity, the distance to the vehicle in front is greater than or equal to the set distance, and the inside temperature is higher than the outside temperature, the air conditioning mode is set as the mixing air mode.

18. The method of the vehicle of claim 12, wherein when the inside humidity of the vehicle is less than or equal to the set humidity, the distance to the vehicle in front is greater than or equal to the set distance, and the inside temperature is lower than the outside temperature, the controller is configured to set the air conditioning mode of the vehicle to the inside air mode.

19. A non-transitory computer readable storage medium on which a program for performing the method of claim 10 is recorded.
